(19) United States
(12) Patent Application Publication
(10) Pub. No.: US 2009/0230687 A1
(43) Pub. Date: Sep. 17, 2009

(54) Electrical generation from water power

(76) Inventor: Gary J. Robichaud, Scarborough (CA)

Correspondence Address: Gary Robichaud, Suite 1502, 250 Brenyon Way, Scarborough, ON, M1B-3G3, CA

(21) Appl. No.: 12/453,948

(22) Filed: May 28, 2009

(30) Foreign Application Priority Data
Apr. 19, 2007 (CA) 2, 586, 244

(51) Int. Cl. H02K 7/18

(52) U.S. Cl. 290/54

(57) ABSTRACT

It is common for the generation of hydroelectric energy, that the use of waterfalls and dams be utilized to drive a turbine for the creation of electricity. In this concept for generating hydroelectric power from water, if one could divert the water, say from a lake by means of a funnel or trap door below the water line of a large lake and have it drop onto an impeller by means of gravity, that one could produce a safe 24/7 renewable energy source. The diverted lake water used to drive the turbine, would then be pumped back into the lake by means of a corkscrew driver, thus creating a void in atmospheric pressure at the bottom of the chamber, where by creating a recycling flow of water which produces no green house gasses, such as coal fired generators.

This concept relates to a process for generating electricity.

Generating electrical power now consists of nuclear, coal fired, gas fired, solar and wind or in some instances, hydroelectric power, all of which except the latter three emit pollutants such as CO.2 into the environment. Solar and wind also have their draw backs where weather can play a contributing factor in their abilities to generate electrical current, leaving hydroelectric being the only one using natural processes for a 24/7 never ending renewable source of power for generating electricity.

With hydroelectric power, you have a generating process which has no emissions, no greenhouse gasses, no toxic waste, or to sum it up, a totally environmentally friendly process for generating electrical current.

Using the weight of falling water and gravity to generate power is nothing new and has been around for hundreds of years.

Using the weight of water from a waterfall and downward gravitational forces to drive such mechanisms as, for example, a grinding wheel for the grinding of wheat, one utilized the weight of the water and the power of gravitational forces to drive the grinding wheel enabling it to produce flour.

The bases for this inventive process being, that there are not many natural waterfalls such as Niagara where the power and force's that are required to produce electricity are readily at hand for harvesting to produce such things as electricity.

In many cases the damming of rivers to create a waterfall is required usually at great cost both economically and environmentally.

Resorting to this inventive process and creating a man made waterfall on a lake such as Lake Ontario, or any lake for that matter, this process of harnessing the force's of water and gravity combined alongside with atmospheric pressure, one could generate electrical current.

An example of the theory proposed in this concept would be; if someone were to submerge an empty mug into a sink full of water, a process known and proven would begin, whereby gravity and atmospheric pressure would cause the water to fall into the empty mug until the mug was fill.

By returning the water back into the sink at the bottom through mechanical means such as a water return corkscrew or pump, a recycling system would begin in which another void at the bottom of the mug would be created and a need due to atmospheric pressure arise and that need would have to be filled.

This recycling system would create a 24/7 marriage of water, gravity and atmospheric pressure to achieve a constant flow of water.

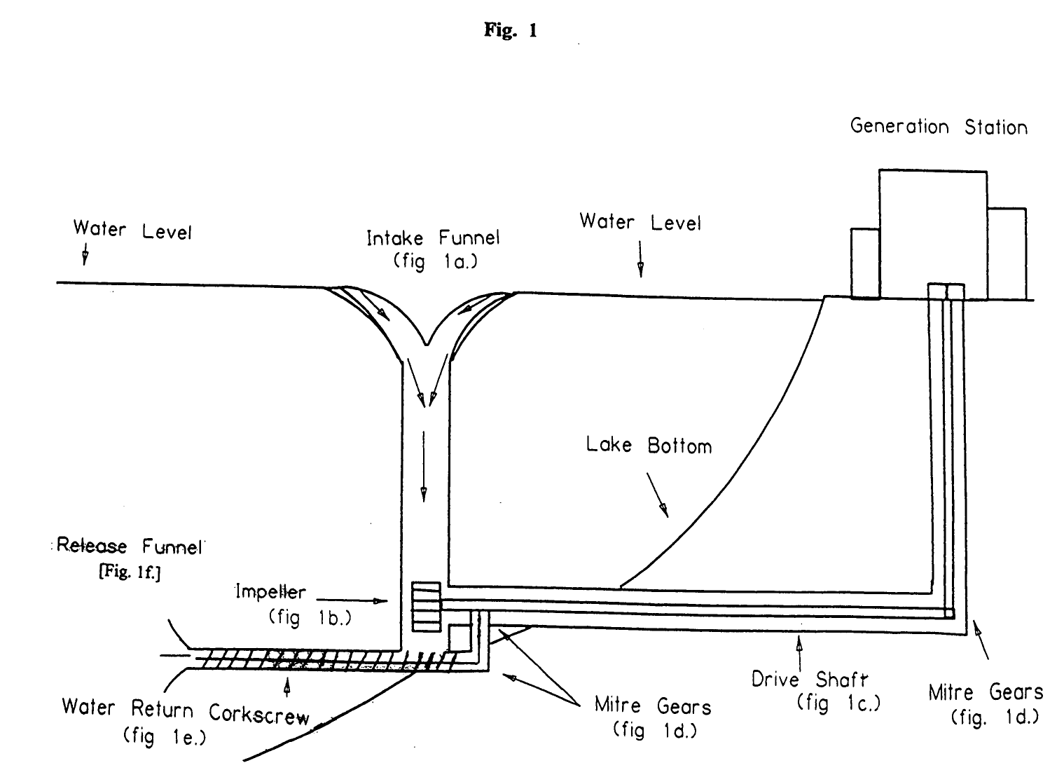

Simply by placing a horizontal turbine placed within the funnel and cross sectioned to the waterfall and being attached to a drive shaft while connected to a generator would complete a process for generating electricity, as illustrated in FIGS. 1 & 2.

The embodiments of this process begins with a funneled intake chamber or channel below the waterline of a lake and able to withstand the pressures of being submerged under water and for receiving the water flow. FIG. 1. (FIG. 1a.)

Using gravity to create a waterfall, the water would then fall onto the blades of a turbine, FIG. 1 (FIG. 1b) which in turn would drive the attached driveshaft FIG. 1. (FIG. 1c)

Use of miter gears FIG. 1 (FIG. 1d) with attached shafts being driven off of the main driveshaft could drive a water return corkscrew, FIG. 1 (FIG. 1e ) to displace the used water power source, creating a void in atmospheric pressure, allowing for the continuous flow of water from the lake.

The displaced water would then exit back into the lake by means of a release funnel FIG. 1 (FIG. 1f) thus creating its own recycling system.

The main driveshaft, FIG. 1 (FIG. 1c) that would be routed to land would then drive a set of miter gears, FIG. 1 (FIG. 1d.) to allow for a land based generator housed in a generating facility to create electrical current.

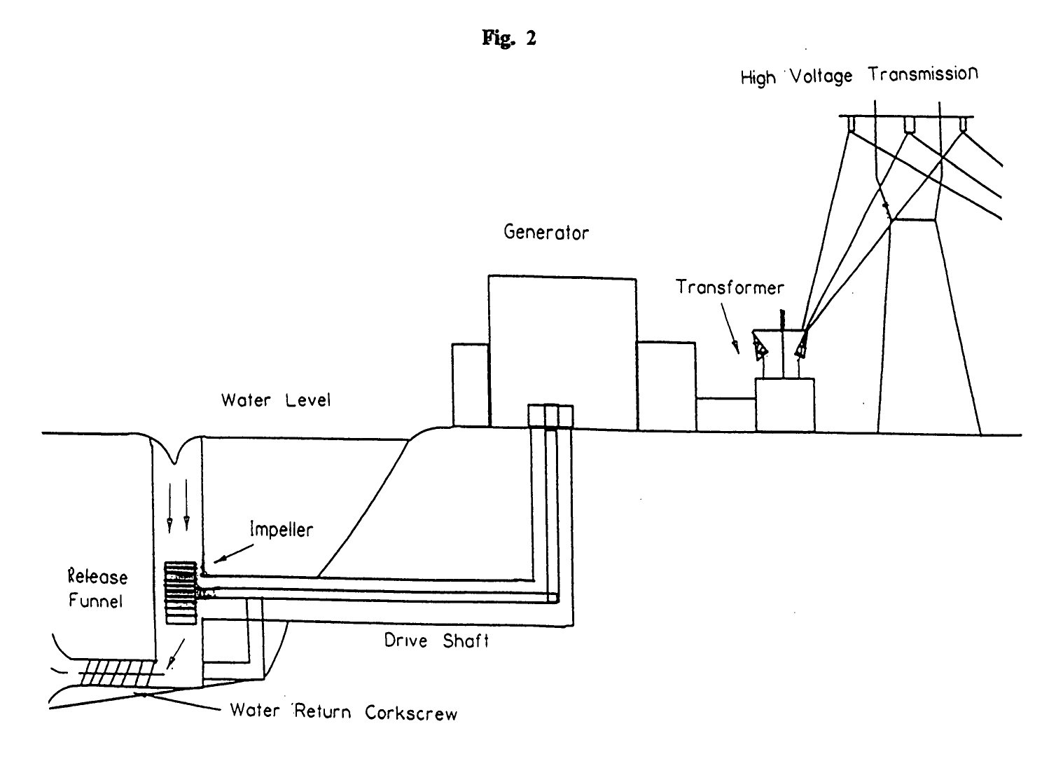

Electrical current is then sent from the generation station by means of the distribution grid of their local utilities, as shown in FIG. 2.

Seeing as the application of process can be adapted to either urban, rural or individual usage it's impossible to state specks, dimensions, materials or tolerances until the usage is established and then would have to be determined.

Other possible usages for this process would be to install an impeller along with a generating system onto things like soil pipes in buildings or sewer systems to generate power from within to light the building or power the street lights.

1.) A process for generating none polluting electrical current by the use of water power, gravity, atmospheric pressure and mechanical means.

2.) A process as defined in claim 1, in which water from a lake, is used to drive a turbine by means of a man made waterfall.

3.) A process as claimed in claim 2, where by harnessing the power and forces of natural accordance along with the use of a turbine, drive shaft and a water return corkscrew driver being of adequate dimension, size and tolerance to receive the flow and pressure of the falling water, as described in the specifications.

4.) A process as claimed in claim 3, where by mechanical means, would involve and require an turbine, drive shaft, water return corkscrew.

5.) A process as claimed in claim 4, where by combining the mechanical aspects of said device and process, being routed to a land generator, would produce electrical current.

6.) A process as claimed in claim 5, for delivering electrical current by means of the electrical grid of any hydro facility as shown in FIG. 2
